(19) United States
(12) Patent Application Publication
(10) Pub. No.: US 2003/0137983 A1
(43) Pub. Date: Jul. 24, 2003

(54) Traffic-engineering scheduling device for multi protocol label switching

(76) Inventor: Whon Song, Suwon City (KR)

Correspondence Address: Robert E. Bushnell, Suite 300, 1522 K Street, N.W., Washington, DC, 20005, US

(21) Appl. No.: 10/321,578

(22) Filed: Dec. 18, 2002

(30) Foreign Application Priority Data
Jan. 24, 2002 (KR) 4128/2002

(51) Int. Cl. H04L 12/56

(52) U.S. Cl. 370/395.4; 370/236

(57) ABSTRACT

The present invention discloses a traffic-engineering scheduling device for multi protocol label switching (MPLS) to perform traffic-engineering functions in the multi protocol label switching (MPLS), comprising a traffic-engineering profile module receiving and processing subscriber information including traffic-engineering path, and information related to the traffic-engineering path, a traffic-engineering scheduling module receiving a time-attributed property for generating/modifying/deleting the traffic-engineering path, and making the traffic-engineering profile module to generate/modify/delete the traffic-engineering path, and a signaling protocol control module controlling a signaling protocol for constructing a routing path, and performing generation/modification/deletion of the traffic-engineering path actually, according to requests of the traffic-engineering profile module. Therefore, it is possible to develop a communication product, or data services changing dynamically the service quality or contents depending on time. As a result, various types of communication products can be developed, and various services can be supplied to subscribers. The telecommunication carrier can maximize efficiency in the network in itself, and even in the marketing fields for the network.

### CLAIM OF PRIORITY

This application makes reference to, incorporates the same herein, and claims all benefits accruing under 35 U.S.C. § 119 from my application APPARATUS FOR TRAFFIC ENGINEERING SCHEDULING OF MULTI PROTOCOL LABEL SWITCHING filed with the Korean Industrial Property Office on Jan. 24, 2002 and there duly assigned Serial No. 4128/2002.

### BACKGROUND OF THE INVENTION

1. Technical Field

The present invention relates to a traffic-engineering scheduling device for multi protocol label switching (MPLS) performing generation, modification, and deletion of the traffic-engineering path by activating or inactivating functions of dynamic traffic-engineering according to the time characteristic through a time-attributed parameter reflecting traffic characteristic in each subscriber.

2. Related Art

Recently, as data traffic increases explosively according to increases of web surfers, requests for quality of service (QoS) and service availability are increased rapidly. For satisfying such requests, and for transmitting a packet from a source host to a destination host, the multi protocol label switching (MPLS), the standard in internet engineering task force (IETF), defines a multi protocol label switching (MPLS) signaling protocol for exchanging label information generated from routing information, a process of generating and deleting a label, and a process technology for passing a predetermined packet through a traffic-engineering path by allocating traffic information for traffic-engineering and explicit path information to a label.

Multi protocol label switching (MPLS) simplifies forwarding functions to provide traffic-engineering functions for improving transmission speed and quality of service (QoS), and for responding to data traffic dynamically. Therefore, the multi protocol label switching (MPLS) is widely applied in the surroundings of high speed switching networks, such as asynchronous transfer mode asynchronous transfer mode (ATM) switching networks, or frame relay networks.

Due at least in part to the rapid expansion of the use of the Internet or World Wide Web, it is believed that there is a need for more improvements related to multi protocol label switching (MPLS). To improve traffic-engineering functions related to multi protocol label switching (MPLS), it would be helpful if a traffic-engineering scheduling device were available for multi protocol label switching (MPLS), with the traffic-engineering scheduling device activating traffic-engineering functions dynamically to generate, modify, or create traffic-engineering path to cope with data traffic time, and to provide services of better quality to subscribers.

### SUMMARY OF THE INVENTION

To overcome the above described problems, the present invention provides a traffic-engineering scheduling device for a multi protocol label switching (MPLS), activating traffic-engineering functions dynamically according to time characteristic in each of subscribers to perform generation, modification or deletion of a traffic-engineering path, and to provide services of better quality for each of the subscribers.

The present invention provides traffic-engineering scheduling device for multi protocol label switching (MPLS) to perform traffic-engineering functions in the multi protocol label switching (MPLS), comprising: a traffic-engineering profile module receiving and processing subscriber information including traffic-engineering path, and information related to the traffic-engineering path; a traffic-engineering scheduling module receiving a time-attributed property for generating/modifying/deleting the traffic-engineering path, and making the traffic-engineering profile module to generate/modify/delete the traffic-engineering path; and a signaling protocol control module controlling a signaling protocol for constructing a routing path, and performing generation/modification/deletion of the traffic-engineering path actually, according to requests of the traffic-engineering profile module.

The information related to the traffic-engineering path includes: an explicit hop address; a quality of service (QoS) parameter; and a forwarding equivalent class (FEC) information. The signalling protocol includes at least one of a constrained-based label distribution protocol (CR-LDP), or a resource reservation protocol-traffic engineering (RVSP-TE). The time-attributed property includes at least one of start time, end time, or period for generating/modifying/deleting the traffic-engineering path.

The traffic-engineering scheduling module further includes: a resoure management module receiving information related to the traffic-engineering path from the traffic-engineering profile module, outputting label information, inner resource information, and network hierarchical header information, and managing resouces related to the multi protocol label switching (MPLS); a forwarding engine receiving the outputted information, analyzing and fabricating the network hierarchical header information; and a forwarding table recording the information fabricated by the forwarding engine.

In accordance with the principles of the present invention, as embodied and broadly described, the present invention provides a scheduling device for multi protocol label switching (MPLS), the device comprising: a traffic-engineering profile module receiving subscriber information including traffic-engineering path and receiving information related to the traffic-engineering path; a traffic-engineering scheduling module receiving a time-attributed property corresponding to at least one selected from among generating the traffic-engineering path, modifying the traffic-engineering path, and deleting the traffic-engineering path; said traffic-engineering scheduling module sending instructions to said traffic-engineering profile module to perform at least one selected from among said generating of the traffic-engineering path, said modifying of the traffic-engineering path, and said deleting of the traffic-engineering path; said traffic-engineering profile module sending request signals in accordance with the instructions received from said traffic-engineering scheduling module; and a signaling protocol control module receiving the request signals from said traffic-engineering profile module, said signaling protocol control module controlling a signaling protocol for constructing a routing path, said signaling protocol control module performing at least one selected from among said generating of the traffic-engineering path, said modifying of the traffic-engineering path, and said deleting of the traffic-engineering path in dependence upon the received signals.

In accordance with the principles of the present invention, as embodied and broadly described, the present invention provides a scheduling device for multi protocol label switching (MPLS), the device comprising: a profile module receiving subscriber information including an identification of a traffic-engineering path and receiving information related to the traffic-engineering path, the subscriber information including at least a subscriber identifier; a scheduling module receiving time-related information corresponding to at least one instruction selected from among generating the traffic-engineering path, modifying the traffic-engineering path, and deleting the traffic-engineering path, said scheduling module sending a notification to said profile module to inform said profile module of a scheduled operation corresponding to at least one selected from among said generating of the traffic-engineering path, said modifying of the traffic-engineering path, and said deleting of the traffic-engineering path, said profile module sending request signals in accordance with the notification, the time-related information including data corresponding to at least one selected from among a start date, an end date, and a time period; and a signaling protocol control module receiving the request signals from said profile module, said signaling protocol control module controlling a signaling protocol for constructing a routing path, said signaling protocol control module performing at least one selected from among said generating of the traffic-engineering path, said modifying of the traffic-engineering path, and said deleting of the traffic-engineering path in dependence upon the received signals.

In accordance with the principles of the present invention, as embodied and broadly described, the present invention provides a scheduling device, the device comprising: a first module receiving subscriber information including an identification of a traffic-engineering path, receiving information related to the traffic-engineering path, receiving time-related information corresponding to at least one instruction selected from among generating the traffic-engineering path, modifying the traffic-engineering path, and deleting the traffic-engineering path, said first module sending request signals in dependence upon at least one selected from among the subscriber information, the information related to the traffic-engineering path, and the time-related information; and a second module receiving the request signals from said first module, said second module controlling a signaling protocol for constructing a routing path, said second module performing at least one selected from among said generating of the traffic-engineering path, said modifying of the traffic-engineering path, and said deleting of the traffic-engineering path in dependence upon the received request signals.

The present invention is more specifically described in the following paragraphs by reference to the drawings attached only by way of example. Other advantages and features will become apparent from the following description and from the claims.

### BRIEF DESCRIPTION OF THE DRAWINGS

In the accompanying drawings, which are incorporated in and constitute a part of this specification, embodiments of the invention are illustrated, which, together with a general description of the invention given above, and the detailed description given below, serve to exemplify the principles of this invention.

FIG. 1 is a schematic configuration of an exemplary communication network supporting a multi protocol label switching (MPLS);

FIG. 2 is a schematic diagram related to setting a label switched path (LSP) in the exemplary node configuration of FIG. 1.;

FIG. 3 is a block configuration diagram of a traffic-engineering scheduling device for multi protocol label switching (MPLS), in accordance with the principles of the present invention;

FIG. 4 is an operation flow chart of the traffic-engineering scheduling device for multi protocol label switching (MPLS), in accordance with the principles of the present invention; and

FIG. 5 illustrates an example of time-attributed parameter inputted by an operator, in accordance with the principles of the present invention.

### DETAILED DESCRIPTION OF PREFFERED EMBODIMENTS

While the present invention will be described more fully hereinafter with reference to the accompanying drawings, in which details of the present invention are shown, it is to be understood at the outset of the description which follows that persons of skill in the appropriate arts may modify the invention here described while still achieving the favorable results of this invention. Accordingly, the description which follows is to be understood as being a broad, teaching disclosure directed to persons of skill in the appropriate arts, and not as limiting upon the present invention.

Illustrative embodiments of the invention are described below. In the interest of clarity, not all features of an actual implementation are described. In the following description, well-known functions, constructions, and configurations are not described in detail since they could obscure the invention with unnecessary detail. It will be appreciated that in the development of any actual embodiment numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill having the benefit of this disclosure.

Exemplars of recent efforts in the art are disclosed, for example, in U.S. Pat. No. 6,430,154 to Hunt et al., entitled SUPPORTING MULTIPLE APPLICATION TRAFFIC TYPES OVER CONNECTION ORIENTED NETWORKS, issued on Aug. 6, 2002, U.S. Pat. No. 6,385,198 to Ofek et al., entitled SIGNALING FOR TIMELY FORWARDING IN PACKET SWITCHING NETWORK WITH A COMMON TIME REFERENCE, issued on May 7, 2002, U.S. Pat. No. 6,377,579 to Ofek, entitled INTERCONNECTING A SYNCHRONOUS SWITCHING NETWORK THAT UTILIZES A COMMON TIME REFERENCE WITH AN ASYNCHRONOUS SWITCHING NETWORK, issued on Apr. 23, 2002, U.S. Pat. No. 6,330,614 to Aggarwal et al., entitled INTERNET AND RELATED NETWORKS, A METHOD OF AND SYSTEM FOR SUBSTITUTE USE OF CHECKSUM FIELD SPACE IN INFORMATION PROCESSING DATAGRAM HEADERS FOR OBVIATING PROCESSING SPEED AND ADDRESSING SPACE LIMITATIONS AND PROVIDING OTHER FEATURES, issued on Dec. 11, 2001, U.S. Pat. No. 6,259,695 to Ofek, entitled PACKET TELEPHONE SCHEDULING WITH COMMON TIME REFERENCE, issued on Jul. 10, 2001, and U.S. Pat. No. 6,038,230 to Ofek, entitled PACKET SWITCHING WITH COMMON TIME REFERENCE OVER INKS WITH DYNAMICALLY VARYING DELAYS, issued on Mar. 14, 2000. While these contemporary efforts contain merit, it is my observation that further improvements can also be contemplated.

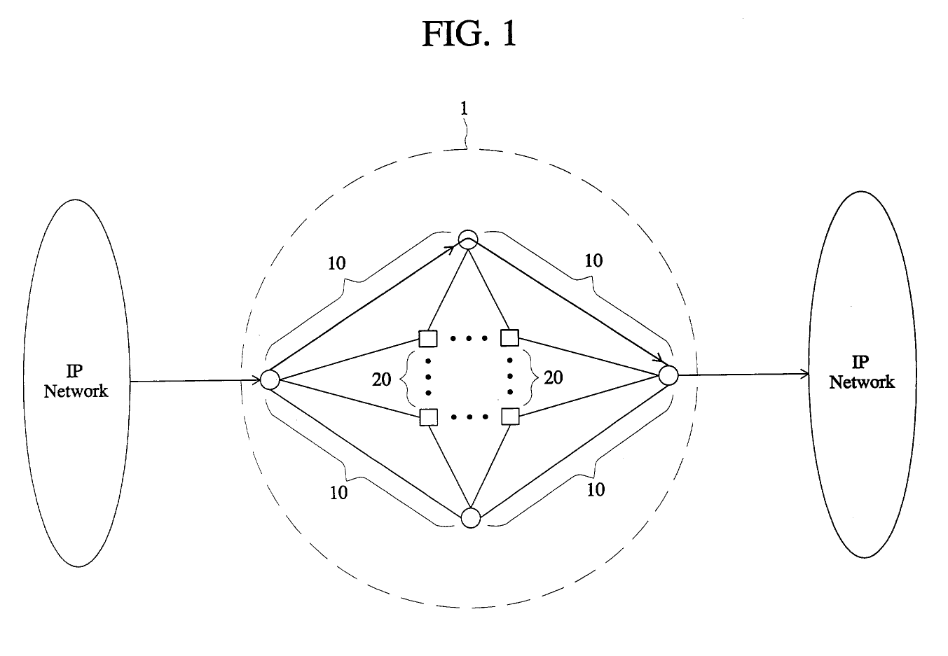

FIG. 1 is a schematic configuration of an exemplary communication network supporting a multi protocol label switching (MPLS). The FIG. 1 shows a network configuration illustrating exemplary multi protocol label switching (MPLS) communication networks schematically. Referring to FIG. 1, the multi protocol label switching (MPLS) network 1 comprises multiple nodes 10 and 20, such as multiple label edge routers (LER) 10 and multiple label switch routers (LSR) 20, connected mutually among them.

A fixed path from each node to other node, in other words a label switched path (LSP), is determined by the multi protocol label switching (MPLS) signaling protocol according to a path setting information from routing table information or manual operations. Therefore, a transmission of the Internet protocol (IP) packet within the multi protocol label switching (MPLS) networks 1 is accomplished through a pre-defined label switched path (LSP) actually.

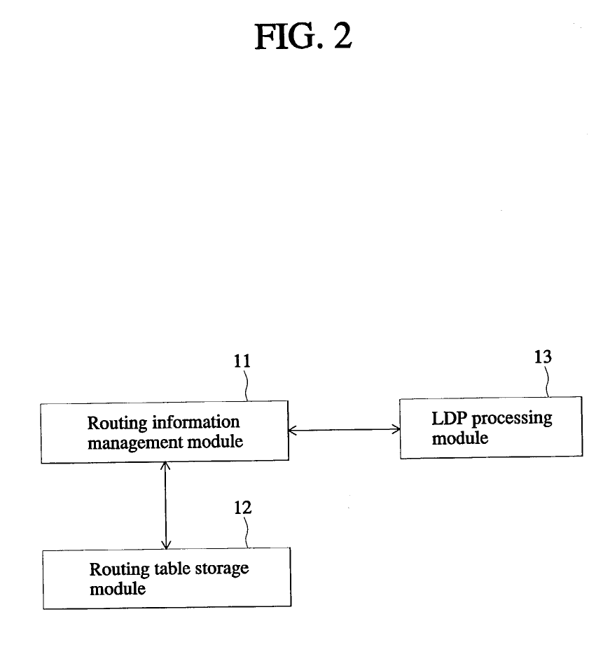

FIG. 2 is a schematic diagram related to setting a label switched path (LSP) in the exemplary node configuration of FIG. 1. Each node includes a routing table storage module 12, a routing information management module 11, and a multi protocol label switching (MPLS) signaling protocol procedure module or a label distribution protocol (LDP) procedure module 13.

The routing table storage module 12 functions as a storage of a destination address and a next hop address during setting a routing path. The routing information management module 11 interchanges routing information with an adjacent node through a routing protocol, modifies and manages routing table information stored in the routing table, and functions as transmitting the routing information to the multi protocol label switching (MPLS) signaling protocol procedure module or the label distribution protocol (LDP) procedure module 13.

In this case, the routing protocol adopts a routing information protocol (RIP), an open shortest path first (OSPF), and a border gateway protocol (BGP). The multi protocol label switching (MPLS) signaling protocol procedure module or the label distribution protocol (LDP) procedure module 13 adopts an allocated label based on the routing information from the routing information management module 11, and transmits the predefined routing information loaded in a label-request message, generated from the multi protocol label switching (MPLS) signaling protocol procedure module or the label distribution protocol (LDP) procedure module 13, to the next node.

The multi protocol label switching (MPLS) system including the above described multiple nodes sets a label switched path (LSP) through the established routing table. At first, a source node of the multi protocol label switching (MPLS) system refers to the routing table including the destination address and the next hop address to set an label switched path (LSP) to a destination node, and transmits the label-request message to the next hop address to allocate an label to the destination address.

Sequentially, the adjacent node corresponding to the next hop address analyzes a forwarding equivalent class (FEC) included in the label-request message to allocate an input label, reports the allocation result of the input label to the previous node that had transmitted the label-request message, and also transmits the label-request message having the predefined routing information to the next node to get an output label.

Therefore, the label switched path (LSP) is set for performing data packet transmission from the source node to the destination node through the above described procedures, and data transmission is performed through the fixed label switched path (LSP). In other words, by best effort services for transmitting packet data through utilizing address information of the destination node only, the data transmission services are achieved.

However, because such best effort services can not satisfy requirements for treating rapid increased data traffic sufficiently, the multi protocol label switching (MPLS) usually supports traffic-engineering functions.

The traffic-engineering functions means functions of setting traffic information, such as bandwidth, to a predetermined path by a protocol dynamically, or by an operator manually, and functions of setting a transmission path without concerning to routing information through establishing explicitly node information for packet transmission to a predetermined destination node.

Such traffic-engineering functions are activated when an operator inputs manually a setting value to generate, to change a new traffic-engineering path, or to delete the pre-defined traffic-engineering path.

However, when the traffic-engineering path is generated, changed or deleted by the operator, dynamic traffic-engineering functions during long term operation cannot be performed effectively. In other words, when data traffic of subscribers is changed periodically—for example, a school or a company having much data traffic during daytime, but less data traffic at night, or an adult broadcasting station having less data traffic during daytime, but much data traffic at night—it will be effective to provide traffic-engineering functions of better quality for much data traffic time. However, in the exemplary system, an operator should activate manually each of the traffic-engineering functions in the data traffic time. Therefore, the exemplary system does not provide dynamic traffic-engineering functions, but static traffic-engineering functions only.

Therefore, it is required to develop a traffic-engineering scheduling device for a multi protocol label switching (MPLS), activating traffic-engineering functions dynamically to generate, modify, or create traffic-engineering path to cope with data traffic time, and to provide services of better quality to subscribers.

Reference will now be made in detail to preferred embodiments of the present invention, example of which is illustrated in the accompanying drawings. Additionally, the same reference number is denoted to the same devices and components for the convenience of understanding, even though the devices or the components in drawings belong to another drawings.

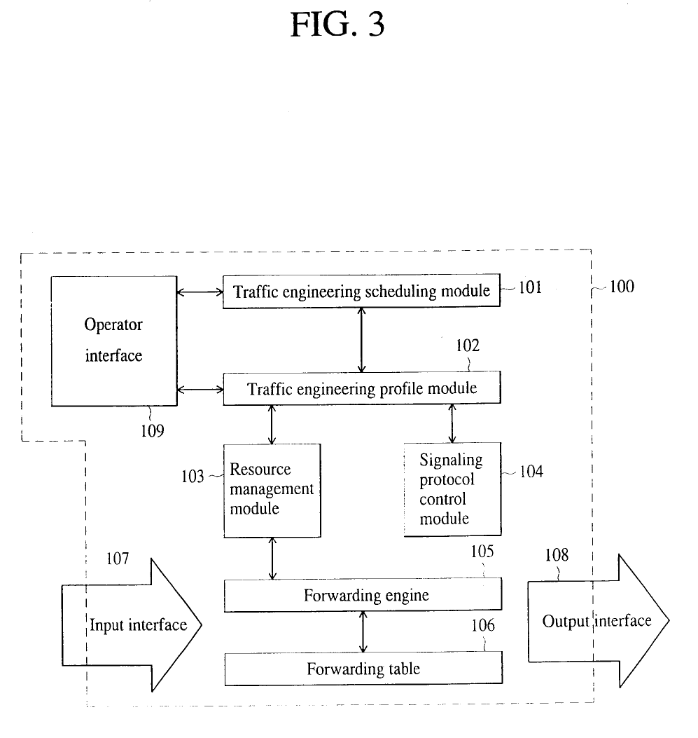

FIG. 3 is a block configuration diagram of a traffic-engineering scheduling device for multi protocol label switching (MPLS), in accordance with the principles of the present invention. Referring to FIG. 3, the multi protocol label switching (MPLS) device 100 of the present invention comprises an operator interface 109, a traffic-engineering profile module 102, a traffic-engineering scheduling module 101, a signaling protocol control module 104, a resource management module 103, a forwarding engine 105, a forwarding table 106, an input interface 107, and an output interface 108.

The operator interface 109 provides operator terminal functions for an operator to control the multi protocol label switching (MPLS) system including the traffic-engineering schedule module 101. Therefore, the operator inputs various control information related to traffic engineering, such as subscriber information, various traffic-engineering parameter information, and traffic-engineering time-attributed parameter information, to the corresponding modules 101 and 102. The operator can check the following results.

The traffic engineering profile module 102 performs functions of receiving, and of processing configuration profiles of service information, such as subscriber information, explicit hop information, quality of service (QoS) parameter information, and forwarding equivalent class (FEC) information.

The traffic-engineering scheduling module 101 receives activation of the traffic engineering, in other words time-attributed parameter related to generating, modifying, and deleting traffic-engineering path, and controls the generation, modification, and deletion of the traffic-engineering path in time schedule.

The signaling protocol control module 104 controls protocols, such as a constrained-based label distribution protocol (CR-LDP) or a resource reservation protocol-traffic engineering (RVSP-TE) for configuring actual routing path, to generate or modify or delete a traffic-engineering path in a time corresponding to the time-attributed parameter predefined in the traffic-engineering scheduling module 101.

The resource management module 103 manages various multi protocol label switching (MPLS) resources, such as label information, inner resource information, and header information in network hierarchical layers for performing traffic-engineering functions, and transmits the multi protocol label switching (MPLS) resources to another module when necessary.

The forwarding engine 105 fabricates packet transmission information from the resource management module 103, and stores the fabricated packet transmission information to the forwarding table 106. The forwarding engine 105 analyzes the network hierarchical header of the packet information received from the input interface 107, attaches a label for a multi protocol label switching (MPLS) recorded in the forwarding table 106, and transmits the packet information to the next node through the output interface 108.

The forwarding table 106 performs mapping to the network hierarchical header, label, and interface information stored by the forwarding engine 105. The input interface 107 interfaces with un-labeled packet information inputted to a label edge router (LER), and the output interface 108 interfaces with labeled packet information outputted to the next node.

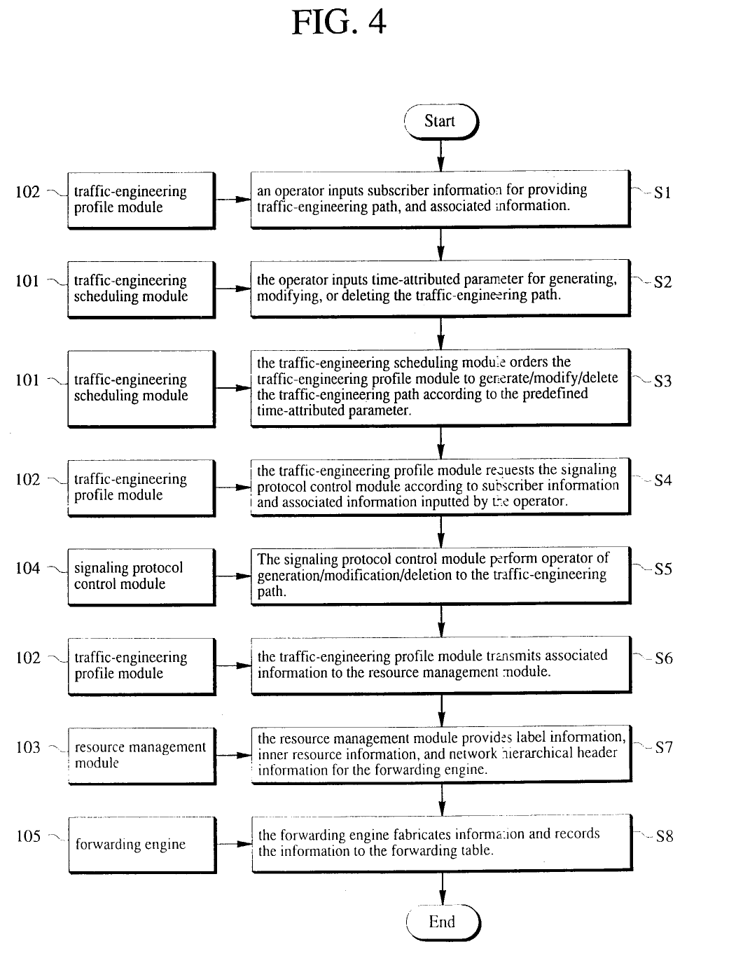

FIG. 4 is an operation flow chart of the traffic-engineering scheduling device for multi protocol label switching (MPLS), in accordance with the principles of the present invention. At step S1, for providing dynamic traffic engineering functions while time passes, an operator inputs associated information, such as subscriber information for providing traffic-engineering path, explicit hop information predefined to the corresponding path, quality of service (QoS) parameter information, and forwarding equivalent class (FEC) information, to the traffic-engineering profile module 102 through the operator interface 109.

At step S2, additionally, by utilizing the above described method, the operator inputs time-attributed parameter for generating, modifying, or deleting the traffic-engineering path, such as start time, end time, period, and another property, to the traffic-engineering scheduling module 101.

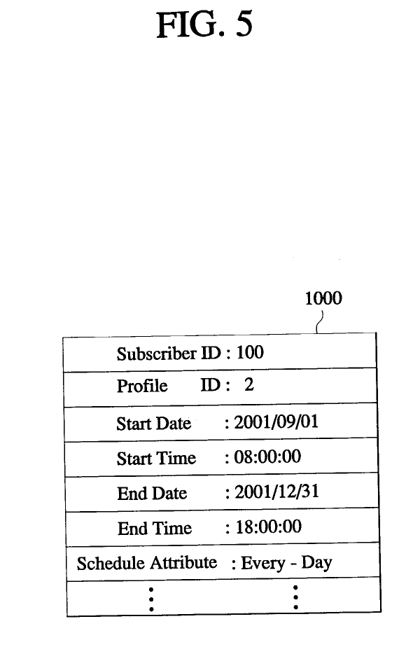

FIG. 5 illustrates an example of time-attributed parameter inputted by an operator, in accordance with the principles of the present invention. The FIG. 5 shows time-attributed parameter 1000. Referring to FIG. 5, the number 100 is allocated to a subscriber identifier or identification number (ID) providing traffic-engineering functions, and the number 2 is allocated to an identification number (ID) of a traffic-engineering path provided to the subscriber.

Additionally, Sep. 1, 2001 is allocated to a start date of the traffic-engineering functions provided to the subscriber, in other words generation, modification, or deletion date of the traffic-engineering path. The start time is set to 8:00, the end date for traffic-engineering functions is Dec. 31, 2001, the end time is set to 18:00, and a schedule attribute is set to everyday.

At step S3, the traffic-engineering scheduling module 101 receives the time-attributed parameter 1000 by the operator and orders the traffic-engineering profile module 102 to generate/modify/delete the traffic-engineering path to provide the traffic-engineering functions according to the predefined time-attributed parameter.

In other words, at step S3, the traffic-engineering scheduling module 101 receives the time-attributed parameter 1000 by the operator and orders the traffic-engineering profile module 102 to generate or modify or delete the traffic-engineering path to provide the traffic-engineering functions according to the predefined time-attributed parameter.

At step S4, sequentially, the traffic engineering profile module 102 requests the signaling protocol control module 104 to generate/modify/delete the traffic-engineering path to the subscriber having an ID of 100 according to subscriber information and associated information inputted by the operator.

At step S5, the signaling protocol control module 104 controls protocols, such as constrained-based label distribution protocol (CR-LDP) or a resource reservation protocol-traffic engineering (RSVP-TE), following to the above requests to perform operations of generation/modification/deletion to the traffic-engineering path, and reports the operation result to the traffic-engineering profile module 102.

At step S6, after receiving the operation result, the traffic-engineering profile module 104 transmits associated information to the resource management module 103. At step S7, sequentially, for the generated/modified/deleted traffic-engineering path, the resource management module 103 provides label information, inner resource information, and network hierarchical header information for the forwarding engine 105.

At step S8, the forwarding engine 105 fabricates information received from the resource management module 103, and records the information to the forwarding table 106. Additionally, an un-labeled packet arriving to the input interface 107 is transmitted into a label packet through the output interface 108 according to the records of the forwarding table 106.

As a result, by adding parameter related to the time-attributed parameter 1000 to the traffic-engineering parameter by the operator, the traffic-engineering path 2 is generated, and the services of traffic engineering functions can be provided to the subscriber of ID 100 from 8:00 to 18:00 everyday during period of Sep. 1, 2001 to Dec. 31, 2001.

To reflect time characteristic of the subscriber in maximum, the setting value in time-attributed parameter is segmented more narrowly to add parameter through the traffic-engineering scheduling module. Therefore, the time characteristic can be applied in maximum.

As described in the above statements, the present invention activates traffic-engineering functions dynamically through the time-attributed parameter reflecting time characteristics of each of the subscribers in the multi protocol label switching (MPLS) system to schedule generation/modification/deletion of the traffic-engineering path. Therefore, services of better quality can be supplied to fit on the requests of the subscribers.

For subscribers, such as a company or a school, service of better quality can be supplied in daytime, and normal best effort services can be supplied at night, because the subscribers get much data traffic in daytime. On the contrary, for subscribers, such as adult broadcasting station, service of better quality can be supplied at night, and normal best effort services can be supplied in daytime, because the subscribers get much data traffic at night.

Therefore, it is possible to develop a communication product, or data services changing dynamically the service quality or contents depending on time. As a result, various types of communication products can be developed, and various services can be supplied to subscribers. The telecommunication carrier can maximize efficiency in the network in itself, and even in the marketing fields for the network.

If the traffic-engineering schedule module 101 and traffic-engineering profile module 102 are combined together to form one unit, that one unit can be referred to as a first module. In this case, the signaling protocol control module 104 can be referred to as a second module.

While the present invention has been illustrated by the description of embodiments thereof, and while the embodiments have been described in considerable detail, it is not the intention of the applicant to restrict or in anyway limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departing from the spirit or scope of the applicant's general inventive concept.

What is claimed is:

1. A scheduling device for multi protocol label switching (MPLS), the device comprising:
a traffic-engineering profile module receiving subscriber information including traffic-engineering path and receiving information related to the traffic-engineering path;
a traffic-engineering scheduling module receiving a time-attributed property corresponding to at least one selected from among generating the traffic-engineering path, modifying the traffic-engineering path, and deleting the traffic-engineering path;
said traffic-engineering scheduling module sending instructions to said traffic-engineering profile module to perform at least one selected from among said generating of the traffic-engineering path, said modifying of the traffic-engineering path, and said deleting of the traffic-engineering path;
said traffic-engineering profile module sending request signals in accordance with the instructions received from said traffic-engineering scheduling module; and
a signaling protocol control module receiving the request signals from said traffic-engineering profile module, said signaling protocol control module controlling a signaling protocol for constructing a routing path, said signaling protocol control module performing at least one selected from among said generating of the traffic-engineering path, said modifying of the traffic-engineering path, and said deleting of the traffic-engineering path in dependence upon the received signals.

2. The device of claim 1, the information related to the traffic-engineering path including an explicit hop address, a quality of service parameter, and forwarding equivalent class (FEC) information.

3. The device of claim 1, the signaling protocol including at least one selected from among a constrained-based label distribution protocol (CR-LDP) and a resource reservation protocol-traffic engineering (RVSP-TE).

4. The device of claim 1, the time-attributed property including at least one selected from among a start time, an end time, and a time period.

5. The device of claim 4, the start time corresponding to a time to start performing at least one selected from among said generating of the traffic-engineering path, said modifying of the traffic-engineering path, and said deleting of the traffic-engineering path.

6. The device of claim 5, the end time corresponding to a time to stop performing at least one selected from among said generating of the traffic-engineering path, said modifying of the traffic-engineering path, and said deleting of the traffic-engineering path.

7. The device of claim 6, the time period corresponding to a period of time for performing at least one selected from among said generating of the traffic-engineering path, said modifying of the traffic-engineering path, and said deleting of the traffic-engineering path.

8. The device of claim 1, said traffic-engineering scheduling module comprising:
a resource management module receiving the information related to the traffic-engineering path from said traffic-engineering profile module, outputting label information, outputting inner resource information, outputting network hierarchical header information, and managing resources related to multi protocol label switching (MPLS);
a forwarding engine receiving the outputted label, inner resource, and network hierarchical header information, said forwarding engine analyzing and fabricating the network hierarchical header information; and
a forwarding table recording the network hierarchical header information fabricated by the forwarding engine.

9. A scheduling device for multi protocol label switching (MPLS), the device comprising:
a profile module receiving subscriber information including an identification of a traffic-engineering path and receiving information related to the traffic-engineering path, the subscriber information including at least a subscriber identifier;
a scheduling module receiving time-related information corresponding to at least one instruction selected from among generating the traffic-engineering path, modifying the traffic-engineering path, and deleting the traffic-engineering path, said scheduling module sending a notification to said profile module to inform said profile module of a scheduled operation corresponding to at least one selected from among said generating of the traffic-engineering path, said modifying of the traffic-engineering path, and said deleting of the traffic-engineering path, said profile module sending request signals in accordance with the notification, the time-related information including data corresponding to at least one selected from among a start date, an end date, and a time period; and
a signaling protocol control module receiving the request signals from said profile module, said signaling protocol control module controlling a signaling protocol for constructing a routing path, said signaling protocol control module performing at least one selected from among said generating of the traffic-engineering path, said modifying of the traffic-engineering path, and said deleting of the traffic-engineering path in dependence upon the received signals.

10. The device of claim 9, the time period corresponding to a period of time for performing at least one selected from among said generating of the traffic-engineering path, said modifying of the traffic-engineering path, and said deleting of the traffic-engineering path.

11. The device of claim 10, the information related to the traffic-engineering path including at least an explicit hop address.

12. The device of claim 11, the signaling protocol including at least one selected from among a constrained-based label distribution protocol (CR-LDP) and a resource reservation protocol-traffic engineering (RVSP-TE).

13. The device of claim 12, said traffic-engineering scheduling module comprising:
a resource management module receiving information related to the traffic-engineering path from said traffic-engineering profile module, outputting label information, outputting inner resource information, outputting network hierarchical header information, and managing resources related to multi protocol label switching (MPLS);
a forwarding engine receiving the outputted label, inner resource, and network hierarchical header information, said forwarding engine analyzing and fabricating the network hierarchical header information; and
a forwarding table recording the information fabricated by the forwarding engine.

14. The device of claim 13, the information related to the traffic-engineering path further including at least a quality of service parameter and forwarding equivalent class (FEC) information.

15. The device of claim 14, the start data corresponding to a date for starting at least one selected from among said generating of the traffic-engineering path, said modifying of the traffic-engineering path, and said deleting of the traffic-engineering path.

16. The device of claim 15, the end date corresponding to a date for ending at least one selected from among said generating of the traffic-engineering path, said modifying of the traffic-engineering path, and said deleting of the traffic-engineering path.

17. A scheduling device, the device comprising:
a first module receiving subscriber information including an identification of a traffic-engineering path, receiving information related to the traffic-engineering path, receiving time-related information corresponding to at least one instruction selected from among generating the traffic-engineering path, modifying the traffic-engineering path, and deleting the traffic-engineering path, said first module sending request signals in dependence upon at least one selected from among the subscriber information, the information related to the traffic-engineering path, and the time-related information; and
a second module receiving the request signals from said first module, said second module controlling a signaling protocol for constructing a routing path, said second module performing at least one selected from among said generating of the traffic-engineering path, said modifying of the traffic-engineering path, and said deleting of the traffic-engineering path in dependence upon the received request signals.

18. The scheduling device of claim 17, the device scheduling multi protocol label switching (MPLS) by performing at least one selected from among said generating of the traffic-engineering path, said modifying of the traffic-engineering path, and said deleting of the traffic-engineering path in dependence upon at least one selected from among the subscriber information, the information related to the traffic-engineering path, and the time-related information.

19. The device of claim 18, the information related to the traffic-engineering path including at least an explicit hop address, a quality of service parameter, and forwarding equivalent class (FEC) information, the signaling protocol including at least one selected from among a constrained-based label distribution protocol (CR-LDP) and a resource reservation protocol-traffic engineering (RVSP-TE).

20. The device of claim 19, the time-related information including at least one selected from among a start time, an end time, and a time period, the start time corresponding to a time to start performing at least one selected from among said generating of the traffic-engineering path, said modifying of the traffic-engineering path, and said deleting of the traffic-engineering path, the end time corresponding to a time to stop performing at least one selected from among said generating of the traffic-engineering path, said modifying of the traffic-engineering path, and said deleting of the traffic-engineering path, the time period corresponding to a period of time for performing at least one selected from among said generating of the traffic-engineering path, said modifying of the traffic-engineering path, and said deleting of the traffic-engineering path.

21. The device of claim 20, said first module comprising:
a resource management module outputting label information, outputting inner resource information, outputting network hierarchical header information, and managing resources related to multi protocol label switching (MPLS);
a forwarding engine receiving the outputted label information, inner resource information, and network hierarchical header information, said forwarding engine analyzing and fabricating the network hierarchical header information; and
a forwarding table recording the network hierarchical header information fabricated by the forwarding engine.
